(19) United States
(12) Patent Application Publication
(10) Pub. No.: US 2007/0228144 A1
(43) Pub. Date: Oct. 4, 2007

(54) PROCESSING TRANSACTIONS USING A REGISTER PORTION TO TRACK TRANSACTIONS

(76) Inventors: Lee Knackstedt, Bear, DE (US); Scott W. Rau, Pottstown, PA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/758,550

(22) Filed: Jun. 5, 2007

Related U.S. Application Data
(63) Continuation-in-part of application No. 11/562,100, filed on Nov. 21, 2006.
Application No. 11/562,100 is a continuation-in-part of application No. 09/630,595, filed on Aug. 1, 2000.

(51) Int. Cl. G06F 7/00

(52) U.S. Cl. 235/376

(57) ABSTRACT

The invention provides methods and systems that keep check of financial transactions by maintaining a count of the financial transactions using a register portion, in conjunction with performing authentication further to inputting transaction data from a data-bearing record that is stored in a device. The system may comprise (A) a communication portion that inputs transaction data received from the data bearing record disposed in the device, the transaction data including an input transaction counter value, the transaction data associated with a transaction; and (B) a processing portion that processes the transaction data. The processing portion may include (1) a memory portion that stores stored data; (2) a register portion that maintains a count of financial transactions so as to provide a current transaction count value associated with the device; and (3) an authentication portion that performs authentication processing using a comparison process that utilizes a transaction count value window and the input transaction count value, the transaction count value window being based on the current transaction count value. The authentication portion may be provided to generate an authentication result based on the comparison process, with the authentication portion outputting the authentication result.

### RELATED APPLICATIONS

This application is a Continuation-in-Part application of U.S. application Ser. No. 11/562,100 filed Nov. 21, 2006 (Attorney Docket No. 47004.000415), which is incorporated herein by reference in its entirety and to which priority is claimed.

Such U.S. application Ser. No. 11/562,100 is a Continuation-in-Part application of U.S. application Ser. No. 09/630,595 filed Aug. 1, 2000 (Attorney Docket No. 47004.000049), which in turn claims priority to provisional U.S. Application Ser. No. 60/774,192 filed Feb. 17, 2006, all such applications being incorporated herein by reference in their entirety and being claimed for priority.

### FIELD OF THE INVENTION

The systems and methods of the invention relate to keeping check of financial transactions using a register portion, in conjunction with performing authentication of the transaction.

### BACKGROUND OF THE INVENTION

It is known in the art to use an ATC (Automatic Transaction Counter), i.e., a transaction count value, which increments for each new transaction. When the cardholder runs a new transaction, the ATC is read and then compared to an ATC value (i.e., assuming an ATC value is maintained by the authentication platform of an authenticator). If respective derived values, i.e., values derived from the ATC values, do not match, then the transaction is denied. This processing prevents fraud by a person who somehow reads (or otherwise acquires) an account number or other information associated with the account. Accordingly, the person attempting the transaction needs the ATC counter to run a transaction.

However, problems occur if the transaction count value of a particular device becomes out of synch with the counter of the authenticating entity. This might happen, for example, if the transaction counter of device is inadvertently incremented.

The invention addresses the above problem, as well as other problems, that exist in known technology.

### SUMMARY OF THE INVENTION

The invention provides methods and systems that keep check of financial transactions by maintaining a count of the financial transactions using a register portion, in conjunction with performing authentication further to inputting transaction data from a data-bearing record that is stored in a device. The system may comprise (A) a communication portion that inputs transaction data received from the data bearing record disposed in the device, the transaction data including an input transaction counter value, the transaction data associated with a transaction; and (B) a processing portion that processes the transaction data. The processing portion may include (1) a memory portion that stores stored data; (2) a register portion that maintains a count of financial transactions so as to provide a current transaction count value associated with the device; and (3) an authentication portion that performs authentication processing using a comparison process that utilizes a transaction count value window and the input transaction count value, the transaction count value window being based on the current transaction count value. The authentication portion may be provided to generate an authentication result based on the comparison process, with the authentication portion outputting the authentication result.

### BRIEF DESCRIPTION OF THE DRAWINGS

The invention can be more fully understood by reading the following detailed description together with the accompanying drawings, in which like reference indicators are used to designate like elements, and in which:

FIG. 1 illustrates an overall transaction architecture according to one embodiment of the invention;

FIG. 2 illustrates an overall architecture of the invention according to a second embodiment of the invention;

FIG. 3 illustrates an activation architecture for the initiation of user accounts according to the invention;

FIG. 4 illustrates a flowchart of transaction processing according to the invention;

FIG. 5 is a diagram showing a validation process utilizing a respective device differentiator number (DDN), assigned to each card, in accordance with one embodiment of the invention;

FIG. 6 is block diagram showing further details of the transaction server 200 in accordance with one embodiment of the invention;

FIG. 7 is a flow chart showing further aspects of transaction processing in accordance with one embodiment of the invention;

FIG. 8 is diagram showing use of multiple device differentiator numbers with one PAN in accordance with one embodiment of the invention;

FIG. 9 is a block diagram showing further details of the authentication portion of FIG. 6 in accordance with one embodiment of the invention;

FIG. 10 is a diagram showing aspects of a transaction count value window that is generated in accordance with one embodiment of the invention;

FIG. 11 is a block diagram showing further details of the spread value determination portion of FIG. 9, in accordance with one embodiment of the invention;

FIG. 12 is a table showing various processing components and rules associated therewith, in accordance with one embodiment of the invention;

FIG. 13 is a flowchart showing a process of generating a window around a transaction count value in accordance with one embodiment of the invention;

FIG. 14 is a flowchart showing further details of FIG. 13, in accordance with one embodiment of the invention; and

FIG. 15 is a diagram showing a look-up table matrix, in accordance with one embodiment of the invention.

### DETAILED DESCRIPTION OF EMBODIMENTS

Hereinafter, aspects of methods and systems in accordance with various embodiments of the invention will be described. As used herein, any term in the singular may be interpreted to be in the plural, and alternatively, any term in the plural may be interpreted to be in the singular.

Features of various embodiments of the invention are described herein. The invention relates to utilization of a payment device in a transaction processing system. The payment device may be any of a variety of devices. The invention relates to identification of the particular payment device used in a transaction and processing associated with such identification. For example, the payment device may be a credit card, a smart card, RFID card, other funds card, a special device for effecting internet purchases, a program operating on a computer system, a key FOB, a device with a bar code, a phone, a device in a keychain, a processing component in an personal music device and/or any other payment device that is used by a user to effect a transaction. For example, the payment device may be a software applet running on the user's computer, which allows access to the user's account. Further, the particular payment device may utilize a variety of technologies to interface with other portions of the transaction processing system. Such interface used by the payment device may include magnetic stripe technology, wireless technology and/or a computer network, for example. For example, as described below in accordance with one embodiment, the invention might utilize RF or RFID technology as an interface between the payment device and the other transaction processing system components. Accordingly, various embodiments of the invention may utilize a variety of systems with differing architecture.

Accordingly, the invention is directed to providing differentiation between such multiple payment devices in the field. In short, any device might be utilized to function as a payment device so long as such device provides information needed to process a transaction, or so long as a customer can transmit the information using the device. However, it is appreciated that the architecture of the transaction processing system, including the payment devices, should preferably be sustained on a global network, i.e., to support global capabilities.

In accordance with one embodiment of the invention, hereinafter features of the invention relating to credit card processing will be described. In running a transaction for a credit card, for example, the card reader typically reads (1) the PAN, (2) expiration date of the card, and (3) discretionary data, for example. All of such information may be read using any suitable reader. The discretionary data may include an ATC (Automatic Transaction Counter), i.e., a transaction count value, which increments for each new transaction. When the cardholder runs a new transaction, the ATC is read and then compared to an ATC value, when an ATC value is maintained by the authentication platform of the card processor, i.e., when a counter is maintained. If respective derived values, i.e., values derived from the ATC values, do not match, then the transaction is denied. This processing prevents fraud by a person who somehow reads (or otherwise acquires) the PAN and expiration data. Accordingly, the person attempting the transaction needs the ATC counter to run a transaction.

A problem in the “multiple cards per PAN” scenario is that each card will have a different ATC (Automatic Transaction Counter) count. For example, the husband may have an ATC value of 10 transactions on his card, and the wife has an ATC value of 25 transactions on her card. Both cards are tied to the same PAN account. If the card processor has an ATC value of 25 (the wife's value) for the shared PAN, and the husband uses his card which has an ATC of 10, obviously the husband's transaction will not go through. The problem is how does the processor in the authentication platform distinguish between the different cards for the PAN? One solution is to issue a different PAN for each payment device that is issued, e.g. one PAN for each credit card. However, this approach would result in an excessive and effectively unmanageable number of PANs. Also, such an arrangement would not allow a user to have multiple payment devices associated with a single PAN, which is often desired. Accordingly, the one PAN for each payment device is not a workable solution.

In accordance with embodiments of the invention, the solution is to give each separate card (or other payment device) its own unique number or some other indicia. Such unique number might be characterized as a Card Sequence Number (CSN) or a Device Differentiator Number (DDN), for example. As used herein, such number (or other indicia) will be referred to as a “Device Differentiator Number (DDN)”.

For example, let's assume the account (PAN) has 4 purchase devices: (1) a first credit card, (2) a second credit card, (3) a first RFID key fob, and (4) a second RFID key fob. Each of the 4 devices is given its own DDN. Each then maintains its own ATC count, and the card processor also maintains an ATC count for each separate DDN. The card processor can not only keep track of which ATC count each device is on, but can also glean substantial information by telling which particular payment device was used to effect which particular transaction.

It is appreciated that while various embodiments of the invention set forth herein include an ATC (Automatic Transaction Counter), e.g., the DDN is used in conjunction with the ATC, such is not needed. Thus, in practice of embodiments of the invention, it is not needed that a particular device utilize, or have, an ATC. For example, in embodiments, a particular device may not use an ATC, but only the DDN as described herein. Thus, the processing of the DDN may or may not be performed in conjunction with (or alongside) the processing of an ATC. As should be appreciated, the utilization of the DDN alone, i.e., without an ATC, lends itself to a wide variety of benefits.

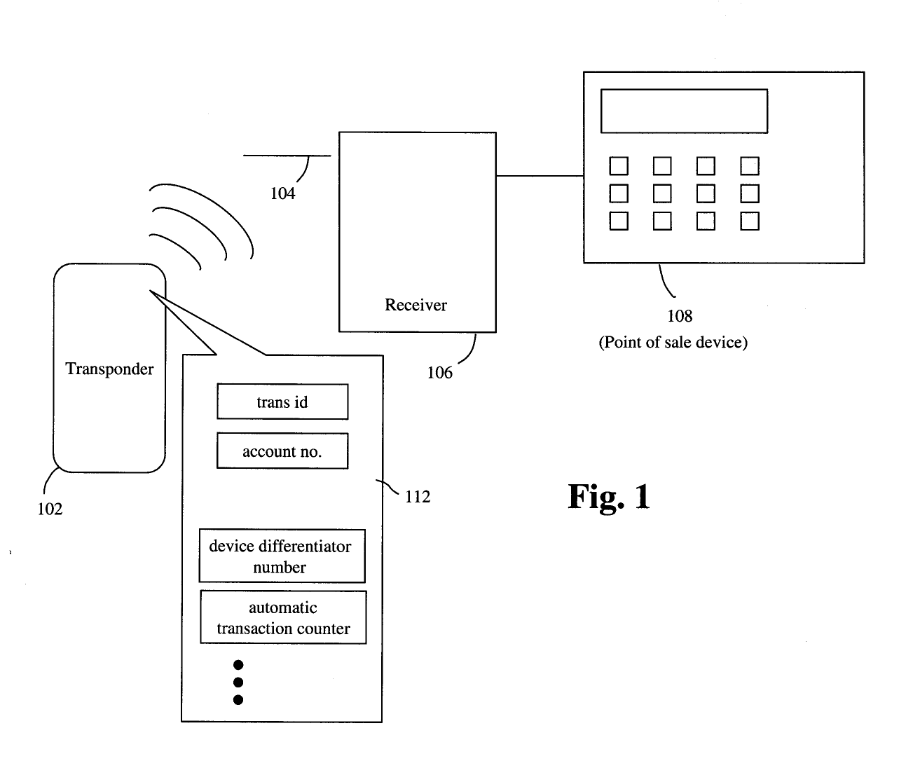

FIG. 1 shows one architecture, in accordance with an embodiment of the invention. FIG. 1 illustrates an overall point of sale architecture that includes a transponder 102 which communicates via an RF link 104 to a receiver 106. The transponder 102 may be or include any of several known electromagnetically coupled devices, generally activated by proximity to an RF-enabled receiving unit, such as receiver 106. Transponder 102 may, for instance, contain an electromagnetic coil antenna for inductive coupling to receiver 106, thereby being energized with small but sufficient electric current to activate embedded electronics within the transponder 102. Those electronics may include memory such as CMOS memory, logic gates, filters for isolating discrete transmission frequencies and other elements known in the art. In one embodiment, transponder 102 may be programmable and able to receive updated programmable instructions via RF link 104, as well as to have electronic memory erased or updated during transactions. Receiver 106 may include an electromagnetic antenna to couple with transponder 102, generally within the range of a few feet of the device.

In the embodiment illustrated in FIG. 1, the receiver 106 is connected to a point of sale (POS) device 108 for conducting a commercial or other transaction. For instance, the point of sale device 108 may be or include any of several commercially known electronic cash registers or related transaction processing equipment, such as point of sale terminals manufactured by Sharp Corp. or others. In one embodiment of the invention, transponder 102 may be embedded within a personal article for convenience, aesthetic and affinity purposes. In that regard, the invention might be integrated in one implementation within a fully functional watch. Embedding in other personal articles, such as key chains, pagers, clothing or other items is also possible. In the operation of the invention, a user who has subscribed to the account system of the invention may approach the receiver 106 at the point of sale device 108 to initiate and complete a purchase or other transaction, such as at a restaurant or grocery market checkout line, or other points of sale. In the embodiment illustrated in FIG. 1, transponder 102 contains an encoded transponder ID 110, which may for instance be a 5-digit number or other identifying information. In this embodiment, transponder 102 may also store an account table 112 directly recording account information for the subscribed user of the transponder 102. The account table 112 may be or include, for example, an account number and other information for a debit account, a cash account, a credit card account, special premises account for internal use such as by employees, or other account information associated with users of the system. The account information in the account table may also include a device differentiator number and an automatic transaction counter (ATC) value.

In the implementation of this embodiment of the invention, receiver 106 is configured to receive the account table 112 and apply an amount being executed at the point of sale device 108 to the account reflected within the account table 112. For instance, a patron who has subscribed to an account according to the system of the invention may approach receiver 106 in a restaurant line and wave a watch or other article containing transponder 102 in proximity of the receiver 106. When transponder 102 comes within range of receiver 106, transponder 102 may be inductively coupled to the coils of an electromagnetic antenna within receiver 106 inducing electrical energy within transponder 102, to establish the RF link 104 with the receiver 106. Upon activation of transponder 102 and radiation of transponder ID 110 to the receiver 106, the receiver 106 may respond with an acknowledge signal to the transponder 102. The point of sale device 108 may indicate on a display screen or otherwise that a transaction is ready to be commenced. Once the point of sale device 108 generates total amount due for the transaction, the receiver 106 may interrogate transponder 102 to obtain account table information from account table 112 for application to the sale.

For instance, if a patron has purchased a meal in a restaurant line at point of sale device 108, the total purchase price may be validated for completion of the transaction. Conversely, if the amount of the transaction cannot be validated, the point of sale device 108 may indicate “cash required” or another message that transponder validation or authorization has failed. If the transaction amount is validated, receiver 106 enters the transaction amount and transmits the revised account table 112 information over the RF link 104 to the transponder 102. A transaction completion signal may be emitted by receiver 106, which in one embodiment may turn off or decouple the transponder 102 via RF link 104.

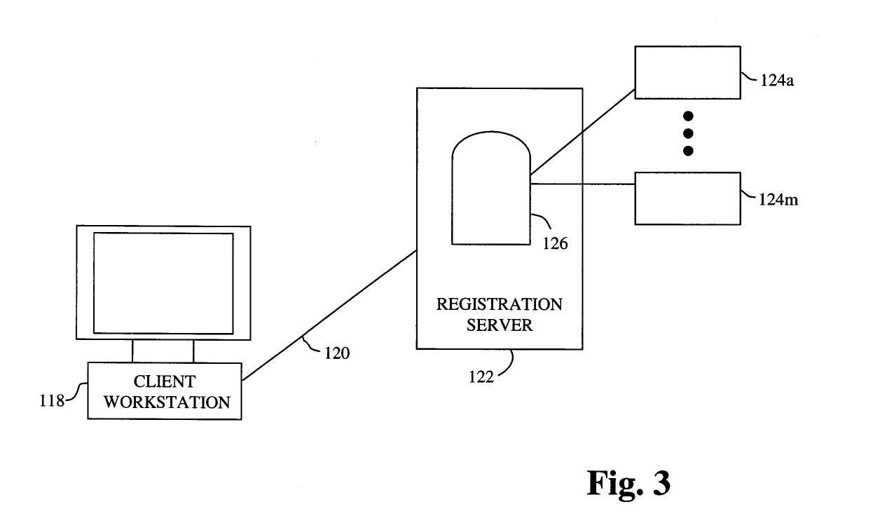

In terms of new accounts registration as illustrated in FIG. 3, in the invention a network-based activation architecture may be advantageously employed. As shown in the figure, a new user may access a client work station 118 connected via communications link 120 to a registration server 122. The communications link 120 may be, include or access any one or more of, for instance, the Internet, an intranet, a PAN (Personal Area Network), a LAN (Local Area Network), a WAN (Wide Area Network) or a MAN (Metropolitan Area Network), a frame relay connection, an Advanced Intelligent Network (AIN) connection, a synchronous optical network (SONET) connection, a digital T1, T3 or E1 line, Digital Data Service (DDS) connection, DSL (Digital Subscriber Line) connection, an Ethernet connection, an ISDN (Integrated Services Digital Network) line, a dial-up port such as a V.90, V.34 or V.34 bis analog modem connection, a cable modem, an ATM (Asynchronous Transfer Mode) connection, or FDDN (Fiber Distributed Data Networks) or CDDI (Copper Distributed Data Interface) connections. Communications link 120 may furthermore be, include or access any one or more of a WAP (Wireless Application Protocol) link, a GPRS (General Packet Radio Service) link, a GSM (Global System for Mobile Communication) link, a CDMA (Code Division Multiple Access) or TDMA (Time Division Multiple Access) link such as a cellular phone channel, a GPS (Global Positioning System) link, CDPD (cellular digital packet data), a RIM (Research in Motion, Limited) duplex paging type device, a Bluetooth radio link, or an IEEE 802.11-based radio frequency link. Communications link 120 may yet further be, include or access any one or more of an RS-232 serial connection, an IEEE-1394 (Firewire) connection, an IrDA (infrared) port, a SCSI (Small Computer Serial Interface) connection, a USB (Universal Serial Bus) connection or other wired or wireless, digital or analog interface or connection.

The registration server 122 may be or include, for instance, a workstation running the Microsoft Windows™ NT™, Windows™ 2000, Windows Vista™, Windows XP™, Unix, Linux, Xenix, IBM AIX, Hewlett-Packard UX, Novell Netware™, sun Microsystems Solaris™, OS/2™, BeOS™, Mach, Apache, OpenStep™, Mac OS X, GAME BOY, PXP or other operating system or platform.

The registration server 122 may communicate with client workstation 118 to receive preassigned information related to transponder 102, such as transponder ID 110 which may be printed by sticker on a watch or other article housing the device, for entry into a database 126 within registration server 122 and the setting up of an account. The account may illustratively include or be more than one type of account 124a . . . 124n, such as cash accounts, debit accounts, credit card accounts, special purpose vending accounts, telephone card accounts, or others. The registration server 122 may validate the transponder ID 110, and interrogate a new subscriber at client work station 118 to identify or select which one or more of accounts 124a . . . 124n the user wishes to associate with the transponder 102.

For instance, the registration 122 may accept a preexisting credit card number for registration with the transponder 102 and execution of future transactions. Once new account information is established, the registration server 122 may communicate via network connection to receiver 106 to update subscriber registration tables within the database 126, receiver 106, point of sale device 108 or other associated hardware to authorize transactions at the point of sale. The paperwork, delay, possibility for error and other drawbacks of paper-based back end account registration is thereby avoided.

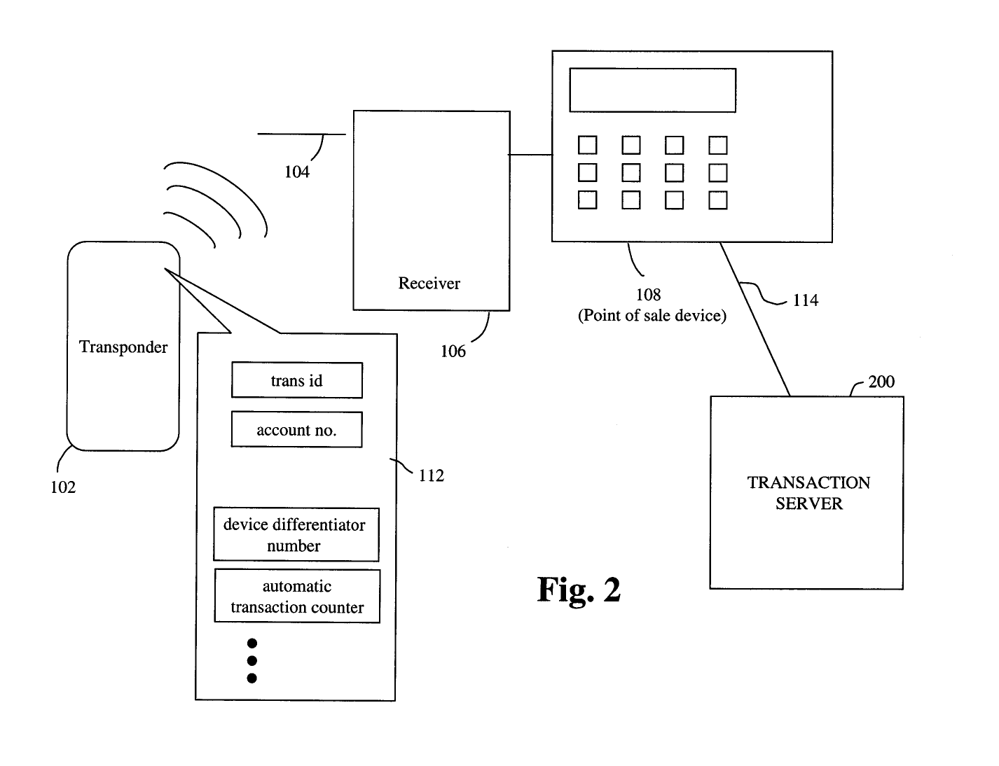

A second illustrative embodiment of the invention is shown in FIG. 2, generally involving a processing architecture similar to that of FIG. 1. In this embodiment, a transponder 102 again communicates via RF link 104 with receiver 106 to effectuate point of sale or other transactions. However, in the embodiment of FIG. 2 a portion or all of account table 112 or other information stored in transponder 102 in the first embodiment may be offloaded to economize on the necessary electronics, power consumption and other properties of transponder 102. In the embodiment illustrated in FIG. 2, the point of sale device 108 is additionally connected to a transaction server 200 via communications link 114, for the purpose of authorizing in whole or in part transactions presented for payment using transponder 102. Communications link 114 may be, include or access communications resources similar to communications link 120.

In this embodiment, part or all of the information of account table 112 may be stored in hard disk or other storage 230 of transaction server 200. Transaction initiation begins in the same manner as the embodiment illustrated in FIG. 1, however, after acknowledgments are exchanged between point of sale device 108 and transponder 102 and a transaction is set up, the point of sale device 108 may communicate with transaction server 200 to validate a transaction amount or other information against account information stored in the transaction server 200.

While this implementation involves additional hardware and communications link 114, if transaction server 200 is co-located with the point of sale device 108, such as in a restaurant or retail outlet, communication delays may be minimal. Furthermore if the transaction server 200 is dedicated to processing transactions only at the site of point of sale device 108 or closely grouped facilities, processing burdens may be comparatively modest. In another embodiment of the invention, transaction server 200 may communicate with remote credit file databases or other information resources before authorizing or completing a transaction initiated over RF link 104 at receiver 106, when circumstances may permit some execution delay to be acceptable.

Alternatively, in another embodiment of the invention the point of sale device 108 may perform a preliminary authorization for transactions presented at the receiver 106, to collect and temporarily store transactions, for instance over 2 or 3 hour periods, for batch processing remotely via transaction server 200. Since the majority of transactions typically reconcile without difficulty, this implementation permits more-immediate completion while still checking on account validations at frequent intervals.

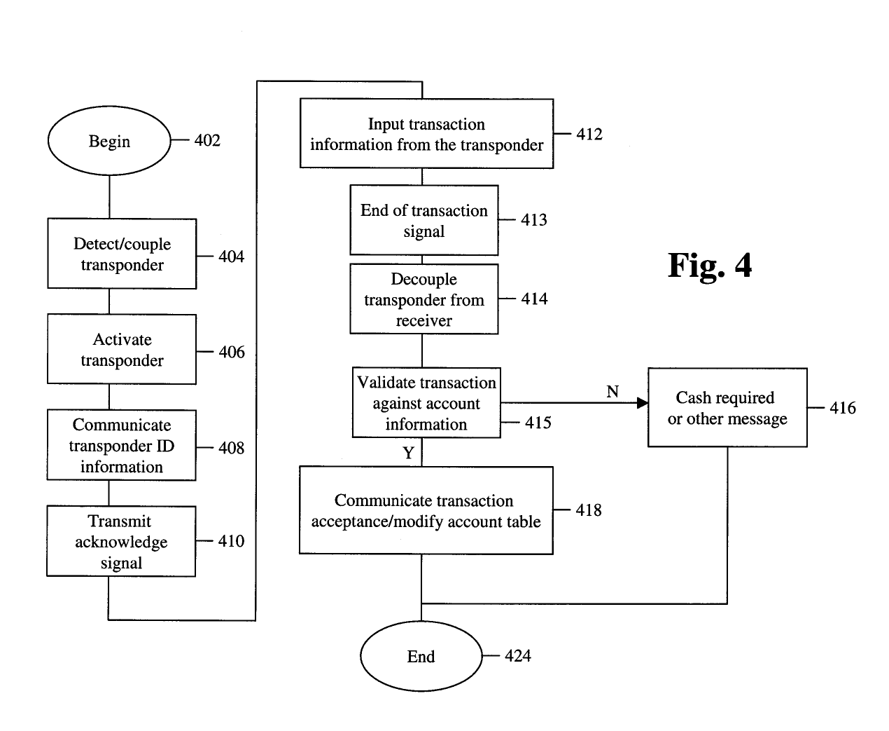

Overall transaction processing is illustrated in the flowchart of FIG. 4. In step 402, processing begins. In step 404, the receiver 106 is presented with transponder 102 within range of electromagnetic coupling, such as inductive coupling. In step 406, transponder 102 is activated, for instance by inductive energization of its circuitry. In step 408 transponder 102 may communicate transponder ID 110, which the receiver 106 acknowledges with an acknowledge signal over RF link 104 in step 410.

In step 412, transaction information is input from the transponder. After step 412, the process passes to step 413.

In step 413, an end of transaction signal is sent to transponder 102. Then, in step 414, transponder 102 decouples from the receiver 106.

In step 415, transaction table 112 or other account information may be interrogated to determine whether account parameters permit the pending transaction at the point of sale device 108, i.e., a validation process is performed on the transaction. If the transaction is not validated, then in step 416 a “cash required” or other message is signaled at point of sale device 108, and processing proceeds to step 424 whole processing ends.

If the account to be applied to the pending transaction is validated at step 414, in step 418, the point of sale device 108 and receiver 106 communicate with transponder 102 to indicate transaction acceptance, and modify information within account table 112 if appropriate. In step 424, processing ends.

The foregoing description of the system and method for transponder-activated transactions is illustrative, and variations in configuration and implementation will occur to persons skilled in the art. For instance, while transponder 102 has been described as electromagnetically coupling with the receiver 106, or other types of detection and coupling could be used. For instance, an infrared device, a biometrically enabled or other device may be presented to corresponding detecting apparatus at the point of sale. Similarly, transponder 102 may contain or store other types or forms of information other than transponder ID 110 and account table 112.

In general, in implementation of the various embodiments of the invention, any type of arrangement may be used to transmit information from the payment device to an transaction processing system. For example, an RF or RFID interface may be used as described herein, as well as any other suitable wireless interface might be used. Other interface arrangements that might be used to communicate information between the payment device and the transaction processing system include a bar code reader, a magnetic stripe reader, a hologram reader, any other visual identifier and associated reader, a key entry device, the Internet or any other computer network, any point of sale (POS) device and/or a phone network or any other communication network or arrangement, for example.

Hereinafter, further details of the architecture and processing of the transaction server 200 will be described in accordance with embodiments of the invention. In particular, aspects of processing by the transaction server 200 relating to the device differentiator number (DDN) will be described. For example, each transponder 102 may be associated with a particular device differentiator number.

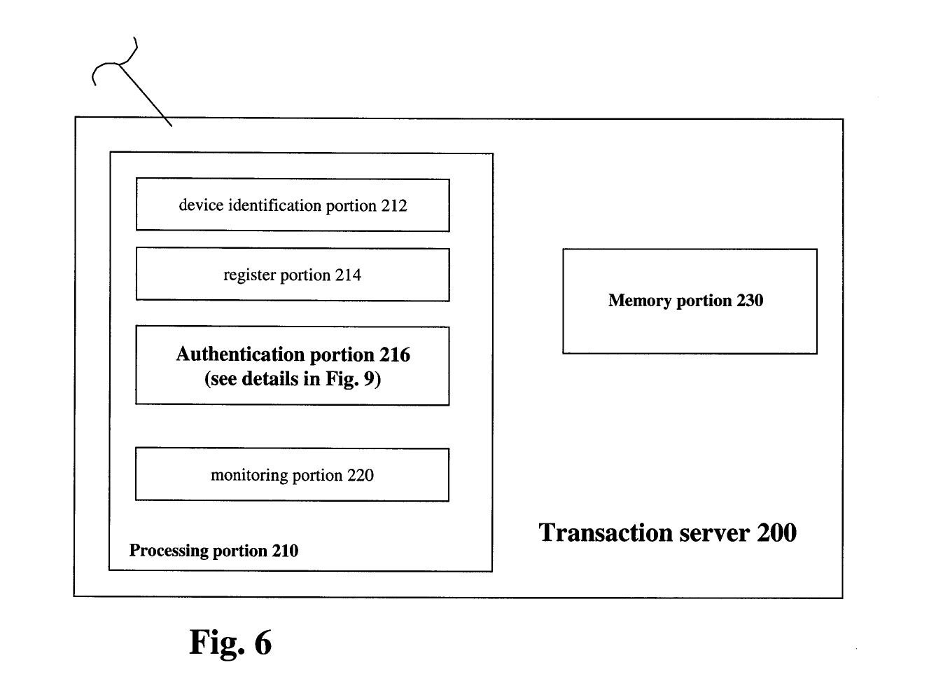

As described herein, the transaction server 200 performs authorization processing for transactions presented for payment using transponder 102. This authorization is performed at the transaction server 200. FIG. 6 is a block diagram showing further details of the transaction server 200 in accordance with one embodiment of the invention.

As shown in FIG. 6, the transaction server 200 includes a processing portion 210. The processing portion 210 performs a variety of processing in the transaction server 200. For example, such processing is related to authorization of a requested transaction and/or monitoring of transactions, for example. The transaction server 200 further includes a memory portion 230. The memory portion 230 may be in the form of a computer readable medium. The memory portion 230 stores a wide variety of data needed in operation of the transaction server 200. Such data may relate to accounts of customers, aggregated data and/or behavior information, for example.

The processing portion 210 includes a number of processing components. Specifically, the processing portion 210 includes a device identification portion 212, a register portion 214 and an authentication portion 216, as well as a monitoring portion 220.

The various processing performed by the components in the processing portion 210 are discussed further below. However, in summary, the device identification portion 212 identifies the device that is associated with a particular requested transaction. The register portion register portion 214 in turn identifies the transaction count value for the particular requested transaction. The authentication portion 216 works in conjunction with the device identification portion 212 and the authentication portion 216 to effect the authentication of the requested transaction. The processing portion 210 also includes the monitoring portion 220. The monitoring portion 220 analyzes data acquired (from the various transactions that are processed by the transaction server 200) for a variety of purposes. For example, the monitoring portion 220 analyzes the data to identify behavior and to prevent fraud.

Hereinafter, further aspects of the invention will be described relating to the use of device differentiator numbers and transaction count values, as well as the associated processing of the transaction server.

Transactions processed by the system of FIG. 1 are typically associated with a transaction account. As described herein, transaction accounts have a Primary Account Number (PAN) which is typically the 16 digit number on the card. In the case of accounts having multiple payment devices, (e.g., credit cards having PAN xxxx xxxx xxxx xxxx with husband and wife each having a respective card), each of the multiple cards is the same. However, authentication processing may be complicated by both a husband and wife (or any other multiplicity of persons) using multiple cards off one PAN. Illustratively, this is true in the situation where a counter is utilized to authenticate transactions associated with the card.

This also becomes a problem in the context of RFID (Radio Frequency IDentification) based cards like the Chase Blink Card, i.e., the Chase card with Blink. The Blink Card is one embodiment of the transponder 102 of FIG. 1. The Blink Card has a magnetic stripe for magnetic stripe processing, as well as an RFID chip for RFID based processing (where one just waves the card past an RFID capable reader). For those RFID based transactions, for example, the card reader (e.g. the receiver 106 of FIG. 1) reads (1) the PAN, (2) expiration date, and (3) discretionary data. All of (1)-(3) are read using the RFID reader off the RFID chip.

The discretionary data may include an ATC (Automatic Transaction Counter) which increments for each new transaction. When the cardholder runs a new RFID transaction, the ATC is read and then compared to an ATC value maintained by the card processor (e.g. JP Morgan Chase's authentication platform). If the derived values do not match, then the transaction is denied. This prevents fraud by a person who somehow reads (or otherwise acquires) the PAN and expiration data.

The problem is that in the multiple cards per PAN scenario, each card will have a different ATC count as those cards are used differently. For example, the husband may have an ATC value of 10 on the husband's card (as a result of making 10 transactions), and the wife has an ATC value of 25 on her card (as a result of making 25 transactions). Both cards are tied to the same PAN account. If the card processor has an ATC value of 25 (my wife's value) for our PAN, and I use my card which has an ATC of 10, obviously my transaction will not go through. The problem is how does the processor distinguish between the different cards for the PAN? In accordance with embodiments of the invention, the solution is to give each separate card its own device differentiator number (DDN), e.g., let's assume the account (PAN) has 4 purchase devices: (1) a first Blink card, (2) a second Blink card, (3) a first RFID key fob, and (4) a second RFID key fob. Each of the 4 devices is given its own DDN. Each then maintains its own ATC count, and the card processor also maintains an ATC count for each separate DDN. For example, each DDN may be stored on several bytes on the card and can be a value between 1-9, for example, to allow up to 9 different cards/fobs (or other devices) for the single PAN. It could be just 3 bits, which would allow up to 8 different values for 8 different cards/fobs or other devices. However, any suitable storage medium might be used (of any suitable size) to store the device differentiator number (DDN). For example, more than 9 values might be needed or desired, i.e., any number of values may be provided for, as desired. In general, any suitable number might be used to differentiate a particular payment device. For example, a numbering scheme might be used to uniquely identify the particular payment device, as well as to reflect that the particular payment device is a member of a family of payment devices. For example, the number of payment devices associated with a particular PAN might be reflected in the device differentiator number.

In one embodiment, the discretionary data (3) that is read off the card according to the invention includes (a) the DDN value, and (b) the ATC value. As a result, the authentication platform (based on the DDN) can identify which device was used to run the transaction. In particular, in the transaction server 200 of FIG. 6, the device identification portion 212 performs this identification. Accordingly, the authentication platform, and specifically the register portion 214 of FIG. 6, will know which ATC value that particular device is on (since the authentication platform retains the last counter it saw from that particular device, for example). In accordance with embodiments of the invention, the device differentiator number (DDN) (assigned to each separate payment device) might be characterized as a static portion, whereas the ATC is the dynamic portion. Once the transaction count value is known for the particular device, based on the device differentiator number, the authentication portion 216 performs authentication processing to determine if the requested transaction should be approved.

The solution to the ATC/multiple cards problem provided by the invention has various other significant benefits. One benefit is that the Digital Authentication Code (DAC) security mechanism can be used.

When the cardholder uses the card in its RFID mode, a DAC may be utilized and is computed by using a card-specific encryption key to compute a code result based on the ATC value read off the card, and a challenge value issued by the RFID card reader. (The computation of the DAC, which is similar to a hash or message authentication code, may also factor in the PAN and expiration date.) The DAC concept is described in U.S. Pat. No. 6,857,566 and U.S. Publication No. 2005/0121512 (continuation of the '566 patent), both assigned to MasterCard and incorporated herein by reference in their entirety. However, since the DAC works off the ATC value of a particular card or device, utilization of the DAC has been problematic in the multiple users/one PAN situation. However, with each card having its own device differentiator number (DDN) in accord with the invention, the authentication platform can discern between different cards or devices, for example. Accordingly, the authentication platform can determine the parameters upon which the DAC was computed, and in particular, the ATC that was used to compute the DAC. It is of course appreciated that DAC processing, or DAC related processing, is certainly not needed in practice of the invention. Rather, any of a variety of authentication processing might be used.

Other benefits of the invention flow from utilization of a respective DDN (assigned to each card/device), and the resulting ability to identify which device effected which transaction. A variety of these benefits may be provided in conjunction with using, or processing, the ATC. For example, through use of a DDN assigned to each separate payment device, the monitoring portion 220 of the transaction server 200 can track statistics on purchasing behavior of each separate cardholder (me versus my wife). In this manner, the device differentiator number (DDN) allows the monitoring portion 220 to granulate purchasing trends amongst various persons having the same PAN.

The DDN can further be used for Point of Sale (POS) loyalty purposes. Even though a husband and wife have the same PAN (i.e., plastic number), the monitoring portion 220 can tell that the wife consistently shops at TIFFANY&Co. (versus other comparables), but that the husband shops at a variety of comparable stores. This in turn may allow for more effective target marketing.

Utilization of the device differentiator number (DDN) can be used in fraud analysis by the monitoring portion 220. For example, if a husband and wife are respectively shopping in New York and LA, the card processor can distinguish between the two cards and legitimatize the transactions.

Utilization of the device differentiator number (DDN) can assist in channel specific authorization, i.e., by the authentication platform (the authentication portion 216) being able to tell which device ran the transaction. For example, a particular PAN might be associated with two payment devices, (1) a credit card with CVV and (2) a cell phone. The authentication portion 216 might be presented with an Internet transaction in which a CVV was presented to the on-line merchant. However, the authentication platform can ascertain whether the transaction was effected by the credit card or the cell phone. If by the cell phone, the authentication platform will know the transaction is fraudulent, i.e., since the cell phone has no CVV associated with it.

Further, a particular payment device may indeed have two device differentiator numbers (DDNs). For example, the Blink Card noted herein may have a DDN associated with the magnetic stripe and a DDN associated with RFID chip. As a result, the card processor (JP Morgan Chase) can tell which part of the Blink Card was used in which transaction. This allows various analysis helpful for marketing purposes, e.g., a determination that the RFID part of the Blink card is extensively used for some transactions.

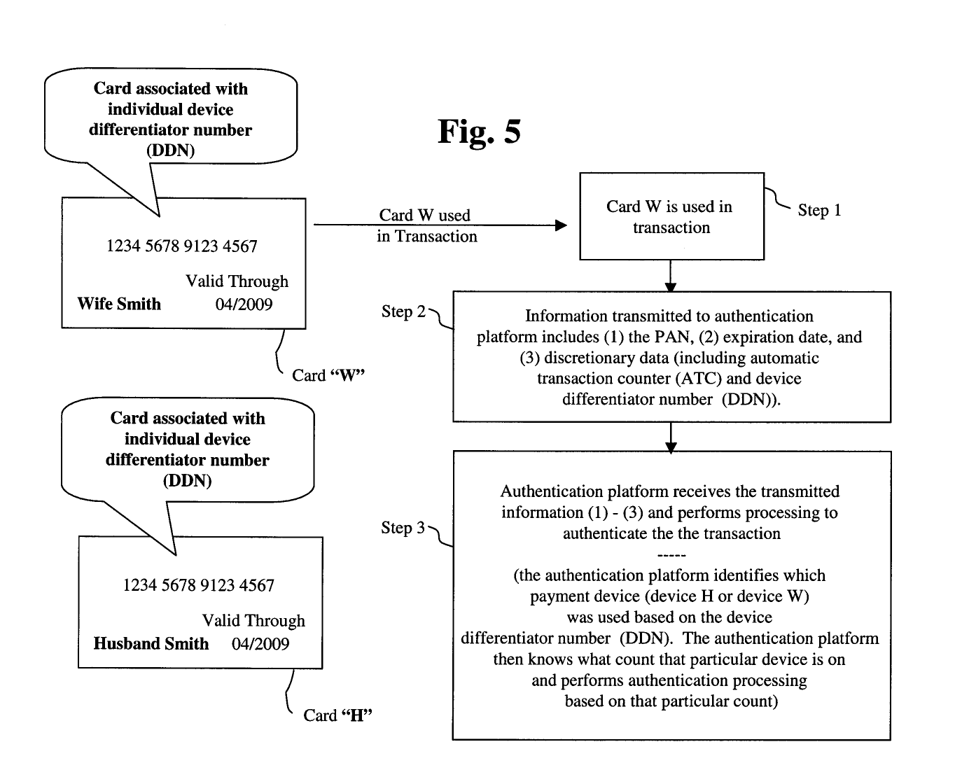

FIG. 5 is a diagram showing a validation process utilizing a respective device differentiator number (DDN), assigned to each card, in accordance with one embodiment of the invention. As shown, both husband and wife (Husband Smith and Wife Smith) have their own physical card. Both cards have the same PAN. However, both cards have their own individual device differentiator number (DDN). The diagram illustrates the wife using her card in a transaction, as shown in step 1. After step 1, the process of FIG. 5 passes to step 2.

In step 2, information is transmitted to the authentication platform including (1) the PAN, (2) expiration date, and (3) discretionary data. The discretionary data includes an automatic transaction counter (ATC) and a device differentiator number (DDN).

After step 2, the process passes to step 3. In step 3, the authentication platform receives the transmitted information (1)-(3) and performs processing to authenticate the transaction. Specifically, the authentication platform first identifies which payment device (card H or card W) was used based on the device differentiator number (DDN), i.e., in this case, the authentication platform determines that card W was used. The authentication platform then determines what ATC count (i.e., what transaction count value) that particular device is on and transact performs authentication processing based on that particular count. The process then ends with the authentication determination being transmitted back to the merchant, for example.

As described herein, a variety of processing and/or analysis can be performed using the device differentiator number (DDN), in addition to the authentication of the transaction. As an alternative to ATC (Automatic Transaction Counter), other authentication techniques may of course be used, e.g. such as time based authentication. However, the device differentiator number (DDN) described herein may well be used in the situation where the device differentiator number (DDN) is not needed for authentication, i.e., for the various other benefits as described herein.

As described in various embodiments herein, a device differentiator number is used to identify a particular payment device in the field. In such embodiments, further features may be implemented that apply particular rules to the authorization processing associated with a payment device.

In accordance with one embodiment of the invention, different rules may be applied to different devices associated with a particular PAN. Use of a particular payment device associated with a PAN may thus be controlled vis-à-vis another payment device associated with the same PAN. For example, the rules may limit which device may be used at which merchant or which type of merchant. Thus, a primary user of a first payment device associated with a PAN may have unlimited use of the PAN. However, the rules associated with a second payment device (provided to an assistant of the primary user) might only allow the assistant to shop at office supply stores, for example. This processing controlling which payment device may be used at which merchants may work off of existing merchant category codes (MCCs), for example, i.e., to determine at which store a customer is shopping. The rules associated with various payment devices (which are associated with the same PAN) may be varied as desired. Rules may hold for all the payment devices associated with a particular PAN, or alternatively, particular rules may apply to only some of the payment devices associated with a particular PAN.

In accordance with one embodiment of the invention, the rules associated with respective payment devices may differentially control the time of day that the particular payment device is usable. Further, the rules may control the amount of funds that are drawn using a particular payment device. For example, an assistant of the main cardholder is only allowed to spend $500 per day.

As described herein, the rules associated with a particular device may provide channel control. That is, a particular device may only be usable via a particular channel or channels. Accordingly, a transaction is denied if a request for the transaction comes through on a channel on which the particular device cannot operate. For example, if a Blink enabled device submits a request via an Internet channel, the rules might dictate for the transaction processing system to decline that transaction (the assumption being that the transaction is fraudulent). The rules controlling the channel control may be varied as desired.

Related to the channel control, in accordance with one embodiment of the invention, an alert system may be used in conjunction with excessive denials associated with the channel control. That is, the transaction processing system may watch for a high rate of denials on a particular channel. Such a high rate of failure may be indicative that indeed such requested transactions are not fraudulent. For example, a new technology might have come on-line which allows a particular payment device to operate on a channel that was previously not possible. The authentication system might then be adjusted to legitimize such transactions.

In accordance with embodiments of the invention, trend tracking is provided to track use of a particular payment device. For example, a user might always have used a payment device on a particular channel. Accordingly, the transaction processing system may be provided to identify a change in the normal channel used by a payment device. Any of a wide variety of other trend tracking capabilities may be utilized based on the capability to distinguish between different payment devices.

Further, an alert system may be used that tracks a particular payment device for particular criteria. The particular criteria to trigger the alert, as well as the manner in which the alert is reported out, may be varied as desired. For example, if a child spends more than $50 in a day (using the child's payment device), the parent might be alerted via a cell phone call. Alternatively, the parent might be suitably alerted if the child shops at a particular type of merchant, e.g. a liquor store.

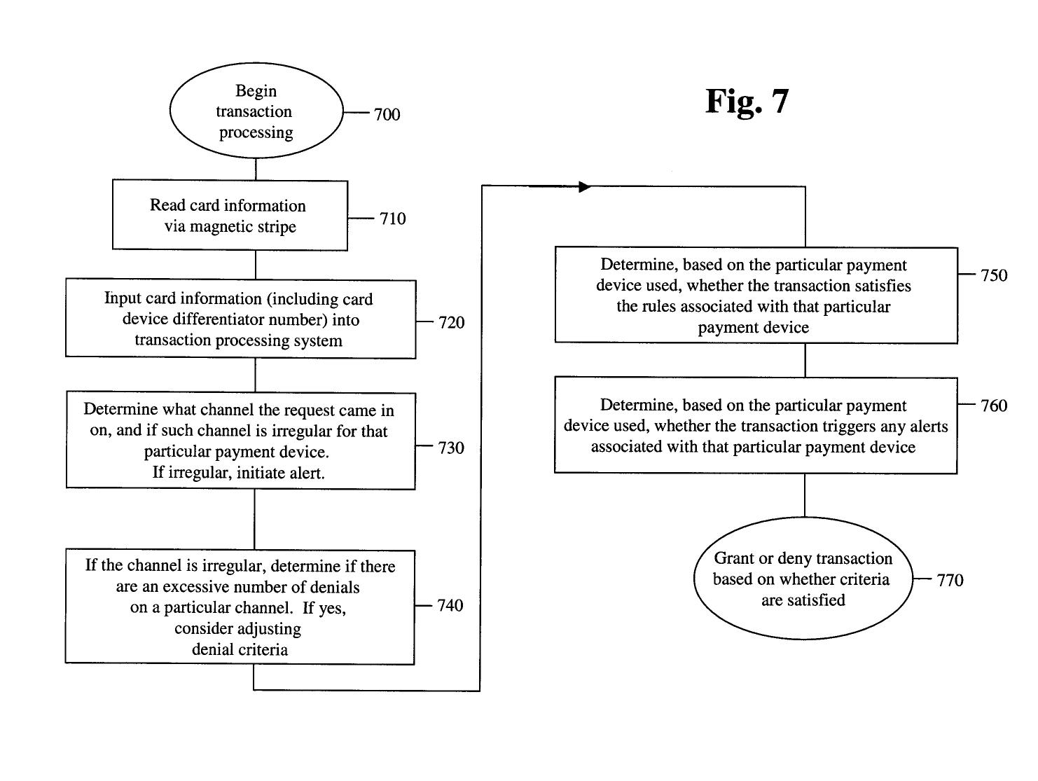

FIG. 7 is a flow chart showing further aspects of transaction processing in accordance with one embodiment of the invention. In particular, FIG. 7 shows aspects of channel monitoring in accordance with one embodiment of the invention. As shown, the process starts in step 700 and passes to step 710. In step 710, in this example, the card information is read via a magnetic stripe. In step 720 the card information (including the DDN) is input into the transaction processing system.

In step 730 the particular channel that the request came in on is determined. Further, the process determines if such channel is irregular for that particular payment device. If it is indeed an irregular channel, an alert is initiated. The alert might be in the form of a call to the customer home number. For example, if the transaction request was for an Internet purchase (and the submitted DDN is associated with a device that cannot do Internet transactions), then an alert would be initiated.

After step 730, the process passes to step 740. In step 740, if the channel is irregular, the process determines if there are an excessive number of denials on a particular channel. If yes, the process considers adjusting the denial criteria. That is, it might be the case that new technology has come to market that provides use of a device on a new channel, i.e., a channel which was not previously usable by the particular device. By monitoring excessive denials on a particular channel and/or for a particular device type, the use of such new technology by a customer might be identified, and the system adjusted appropriately.

After step 740 of FIG. 7, the process passes to step 750. In step 750, the process determines, based on the particular payment device used (as identified by the DDN), whether the transaction satisfies any rules associated with that particular payment device. Then, in step 760, the process determines, based on the particular payment device used, whether the transaction triggers any alerts associated with that particular payment device. For example, the DDN might be associated with the daughter's credit card, and once a dollar amount is attained, an alert is sent to the parent's. In step 770, the process grants or denies the transaction based on whether criteria are satisfied, i.e., is the request authorized

Hereinafter, further aspects of embodiments will be described. As described herein, discretionary data may include an ATC (Automatic Transaction Counter) which increments for each new transaction. It is appreciated that the ATC of a particular payment device may be inadvertently incremented so as to be out of synchrony with the transaction processing system (and the authentication performed thereby). For example, a payment device may be inadvertently read or energized so as to inadvertently increment the ATC of such payment device. Accordingly, the transaction processing system may be provided with a processing capability to accommodate such inadvertent incrementation of the ATC. For example, if an ATC value for a transaction is not valid, the transaction processing system might look ahead, i.e., increment, several values to determine if such ATC values might result in validation of the transaction.

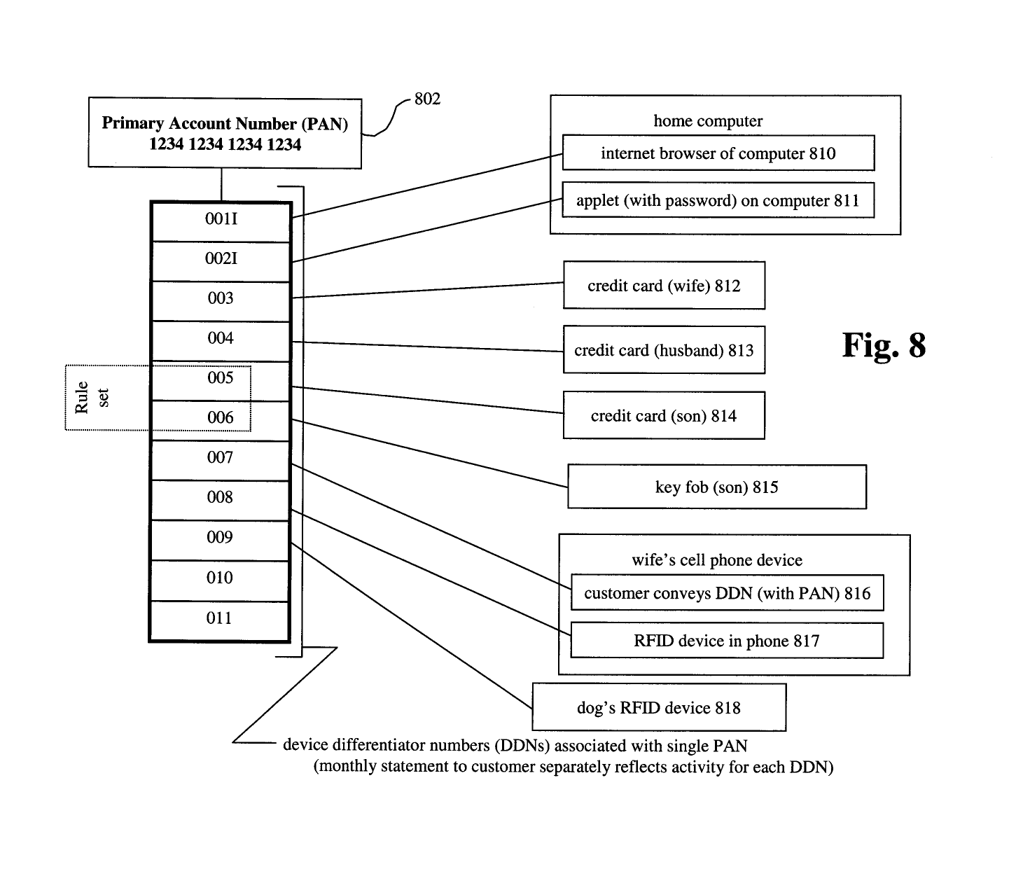

In summary of aspects of the invention, and in explanation of yet further features, FIG. 8 is diagram showing use of multiple device differentiator numbers with one PAN in accordance with one embodiment of the invention.

As illustrated in FIG. 8, one PAN 802 is associated with a plurality of devices (810-818), i.e., any of the devices (810-818) may be used by the customer (or the customer's family) to access funds in the PAN account. This association is accomplished using a respective device differentiator number for each device (810-818). In requesting a transaction, the device differentiator number (associated with the particular device used) is sent to the authenticating entity along with the ATC (Automatic Transaction Counter) for the particular device. Typically, the PAN is also forwarded with a transaction request. As described in detail above, based on the PAN and the DDN submitted, the authenticating entity determines whether the ATC (also submitted) is valid. Accordingly, in accordance with one embodiment of the invention, any of a wide variety of devices may be used so long as such devices may provide the ATC, the DDN and the PAN values (or information by which the ATC, the DDN and the PAN are derivable). However, as described herein, devices that do not use an ATC may also be utilized, i.e., so as to realize the various benefits associated with use of a DDN, without an ATC.

For example, as described above, typically, the PAN is also forwarded with a transaction request. However, this may not always be the case. For example, the PAN might be somehow suitably derived from other information contained in the request. For example, a single PAN might be associated with a particular phone number, and thus derivable by the authenticating entity based on the phone number as described, for example, in U.S. Pat. No. 7,103,576 (U.S. patent application Ser. No. 09/956,997-Attorney Docket No. 47004.000172). Accordingly, the features described in U.S. Pat. No. 7,103,576 may be used in conjunction with the features described herein.

FIG. 8 shows illustrative devices which might be used in the practice of the invention. For example, the DDN 0001I is associated with the internet browser 810 of the customer's computer. That is, when the customer (or a member of the customer's family) submits a transaction using the browser 810, the ATC, the DDN and the PAN is submitted in some suitable manner, such as by the user typing in such information and/or through use of a cookie on the customer's computer, for example. Alternatively, the customer might use a password protected applet 811 on the same physical computer to submit a transaction request associated with the DDN 002I. Each of these are considered a “device” having an associated device differentiator number (DDN), i.e., so the authenticating entity can determine which device was used. In turn, the authenticating entity can separately track (and separately report in a statement to the customer) transaction activity associated with the two devices 810, 811).

FIG. 8 also shows that the wife's credit card 812 is associated with the DDN 003; the husband's credit card 813 is associated with the DDN 004; the son's credit card 814 is associated with the DDN 005; and the son's key fob 815 is associated with the DDN 006. Thus, the authenticating entity can distinguish between purchases made by these respective devices.

Further, FIG. 8 shows that transactions may be submitted using the wife's cell phone, via devices 816 and 817. For example, the DDN 007 may be verbally conveyed by the wife in a telephone call, the PAN identified from the incoming cell phone number, and the ATC conveyed by the output of a suitable tone. The physical phone might also contain an RFID device, which is associated with a separate DDN (008).

Lastly, the DDN 009 is shown as associated with a dog's RFID device. Such device might be used when the dog is placed in a kennel, for example. The user could drop off and pick up the dog without ever dealing with any sign-in sheet or other administrative matter. Rather, the dog's presence would be tracked via interface with the RFID device 818.

It is appreciated that a wide variety of devices may be used. Each device may be associated with its own DDN. For example, an RFID device (with DDN) might be provided to interact with a gasoline filling station, such as an automobile, boat or personal watercraft filling station.

FIG. 8 also illustrates, as described above, that particular rules might be associated with particular DDNs, i.e., particular devices associated with the particular DDNs. For example, as shown, a rule set might be applied to the DDNs 005 and 006 to limit spending activity of a son.

FIG. 8 also shows that the form of the DDN may vary as desired. For example, the DDN 0011 denotes, for example, that such DDN is associated with a device that is expected to effect Internet transactions. The dog's RFID device 818, on the other hand, is not expected to effect Internet transactions. Thus, an Internet transaction submitted using the PAN 802 with the DDN 009 would be flagged as potentially fraudulent.

In accordance with one embodiment of the invention, a customer may be provided with the ability to vary the rules associated with some or all of the DDNs associated with their PAN. In one embodiment, the user might vary the rules based on rule level. For example, all the devices (DDNs) of the customer personally might be considered to be at a first level. On the other hand, all the devices of the customer's son might be considered to be at a second level. Accordingly, the customer might collectively vary the rules at either the first or second level. For example, at the second level, the customer might collectively change all the son's devices (as identified by the authenticating entity using the DDNs) to have a maximum per day limit of $100 versus $50.

In accordance with one embodiment of the invention, the ability to uniquely identify a particular payment device (based on information submitted in the transaction request) allows the ability to segregate purchases associated with a particular PAN based on which payment device effected the particular purchase. That is, in a typical situation, several payment devices will be associated with a single PAN. The primary account holder (or a representative thereof) will typically receive a monthly statement of all the transactions associated with the particular PAN. The invention allows segregation of the transactions (in a statement) based on which payment device effected the transaction. This segregation may be performed in a variety of ways as desired. For example, all the transactions associated with all the primary account holders payment devices may be set out in one listing, while the transactions effected by the children's payment devices may be set out in a separate listing. The particular arrangement may be varied as desired. For example, if electronically viewed (such as over the Internet) various view options may be provided as desired. The various views may segregate the transactions (based on which payment device effected the transaction) in any manner desired. The user would then be provided suitable options to select which view the user wishes to review.

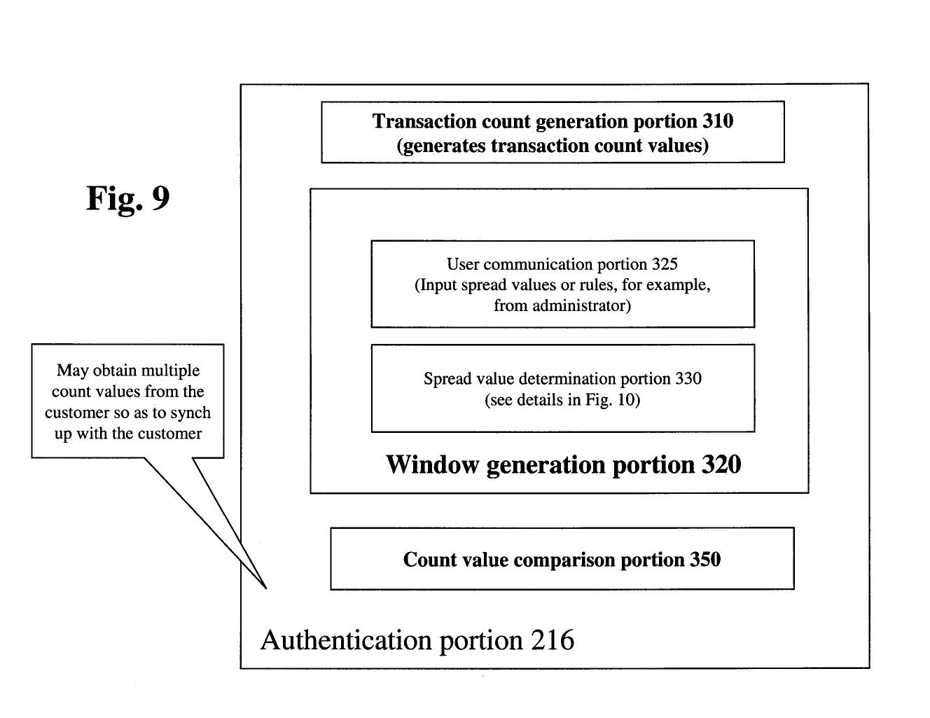

In accordance with embodiments of the invention, hereinafter further features of the invention relating to processing using an ATC (Automatic Transaction Counter) will be described. Features of such embodiments are shown in FIGS. 9-12. As described above, in running a transaction for a device, such as a credit card, for example, a reader may read (1) the PAN, (2) expiration date of the card, and (3) discretionary data, for example. All of such information may be read using a suitable reader.

The discretionary data may include an ATC (Automatic Transaction Counter), i.e., a transaction count value, which increments for each new transaction. When the customer runs a new transaction, the ATC is read and then compared to an ATC value generated by the authentication platform of the authenticating entity. This is assuming that indeed an ATC value is maintained by the authentication platform. It is appreciated that some authentication platforms may not use or maintain a counter. For example, the low risk of a particular transaction (or of a particular device) may not warrant the use of an automatic transaction counter.

In the situation where a counter is used by the authenticating entity, if the two ATC values (the ATC value input from the customer and the ATC value generated by the authentication platform) do not match, then the transaction may be denied. This processing prevents fraud by a person who somehow reads (or otherwise acquires) the PAN and expiration data. Accordingly, the person attempting the transaction needs to provide an ATC value to run a transaction.

Various aspects of utilization of a device differentiator number (DDN) is described above. In use of the DDN, the authentication platform, and the register portion 214 of FIG. 6, will know which ATC value that a particular device is on (since the authentication platform retains the last counter it saw from that particular device, for example). In accordance with some embodiments of the invention, the device differentiator number (DDN) described above (assigned to each separate payment device) might be characterized as a static portion, whereas the ATC is the dynamic portion. As described above, once the transaction count value is known for the particular device, based on the device differentiator number, the authentication portion 216 performs authentication processing to determine if the requested transaction should be approved.

As described above, the authentication portion 216 (as shown in FIG. 6) performs processing to effect the authentication of a requested transaction. In accordance with embodiments described above, the authentication portion 216 works in conjunction with the device identification portion 212 to effect the authentication of the requested transaction. Hereinafter various further features of processing of the authentication portion 216 will be described in accordance with further embodiments. In some such further embodiments, the authentication portion 216 performs processing working with the device identification portion 212 (and utilizes DDN related features as described above). However, in other embodiments, the authentication portion 216 does not utilize the device identification portion 212 (and does not utilize DDN related features as described above).

The embodiments hereinafter described relate to variance between the ATC value provided by the customer and the ATC value maintained by the authenticating entity. As noted above, it is appreciated that the ATC of a particular payment device may be inadvertently incremented so as to be out of synchrony with the transaction processing system, i.e., the authenticating entity. For example, a payment device may be inadvertently read or energized so as to inadvertently increment the ATC of such payment device. Accordingly, the transaction processing system as described herein may be provided with a processing capability to accommodate such inadvertent incrementation of the ATC. For example, if an ATC value for a transaction is not valid, the transaction processing system might look ahead, i.e., increment, several values to determine if such ATC values might result in validation of the transaction.

FIG. 9 is a block diagram showing further details of the authentication portion 216 in accordance with one embodiment of the invention. As shown in FIG. 9, the authentication portion 216 includes a transaction count generation portion 310, a window generation portion 320, and a count value comparison portion 350.

The transaction count generation portion 310 generates transaction count values (ATC) on an ongoing basis. The window generation portion 320 generates a window of transaction count values, i.e., a range of transaction count values. The count value comparison portion 350 compares the transaction count value input from the customer (for a particular transaction) with the transaction count value window to determine if the input transaction count value falls within the transaction count value window.

As shown in FIG. 9, the window generation portion 320 includes further processing components. That is, the window generation portion 310 includes a spread value determination portion 330 and a user communication portion 325.

The user communication portion 325 provides communication (i.e., a communication channel) between the window generation portion 320 and a user, such as a human administrator or another processing component, for example. For example, the user might interface (via the user communication portion 325) with the spread value determination portion 330 (in the window generation portion 320) to manually vary “spread values” (as described below). Alternatively, the user might vary the rules or processing, for example, that the spread value determination portion 330 uses to generate the spread values.

The window generation portion 320 also includes the spread value determination portion 330. The spread value determination portion 330, as described in detail below, generates the spread values that the window generation portion 320 uses to generate the transaction count value window. The spread values may be based on particulars of the transaction and/or a rule set, for example.

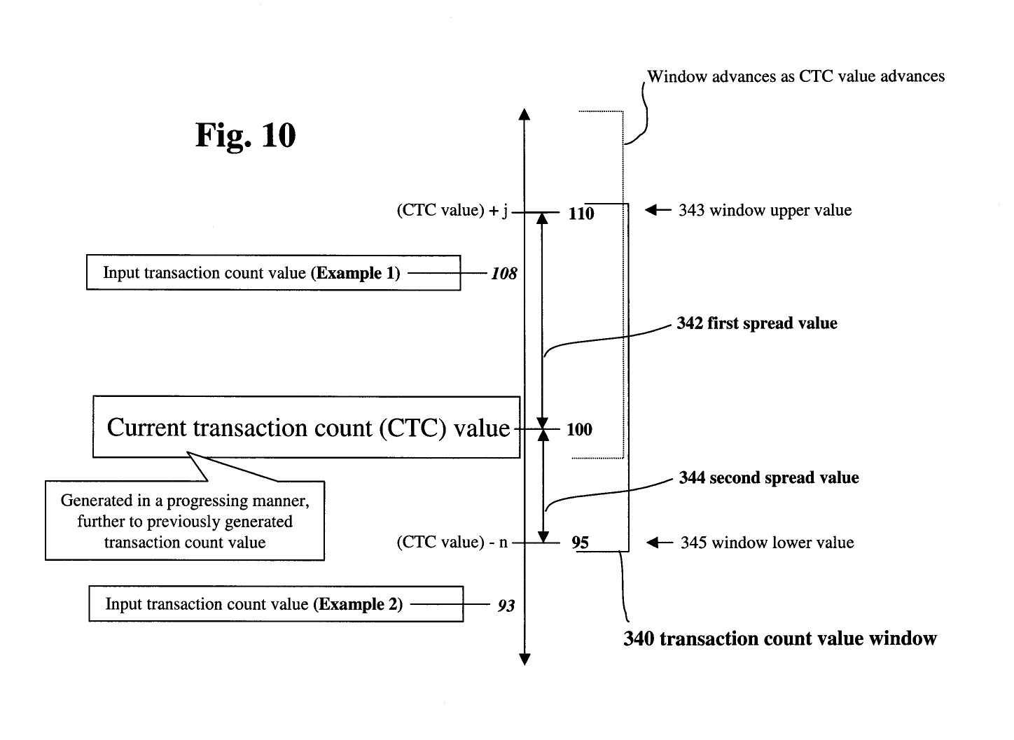

FIG. 10 is a diagram showing aspects of a transaction count value window that is generated by the window generation portion 320 in accordance with one embodiment of the invention. In accordance with one embodiment, the transaction count generation portion 310 generates transaction count values on an ongoing basis as described above. The transaction count generation portion 310 forwards the current transaction count value 341 to the window generation portion 320.

Also, the spread value determination portion 330 generates spread values. The spread value determination portion 330 forwards the generated spread values to the window generation portion 320. Such spread values may include an upper spread value 342, a lower spread value 344, or both.

Based on the current transaction count value and the spread values, the window generation portion 320 generates a transaction count value window 340. That is, in accordance with one embodiment of the invention, the window generation portion 320 takes the current transaction count value 341 and adds the upper spread value 342 thereto:

CTC value+j, where “j” is the upper spread value 342.

The resulting sum is the window upper value 343. The window upper value 343 is the highest input transaction count value that the authentication portion 216 will authenticate. On the other hand, the window generation portion 320 takes the current transaction count value 341 and subtracts the lower spread value 344 there from:

CTC value−n, where “n” is the lower spread value 342.

The resulting value is the window lower value 345. The window lower value 345 is the lowest input transaction count value that the authentication portion 216 will authenticate. Accordingly, a range of acceptable input transaction count values is generated. The range extends from the window lower value 345 to the window upper value 343. Note that either the upper spread value 342 and/or the lower spread value 344 may indeed be zero, thus meaning that the current transaction count value would define at least one end of the acceptable range.

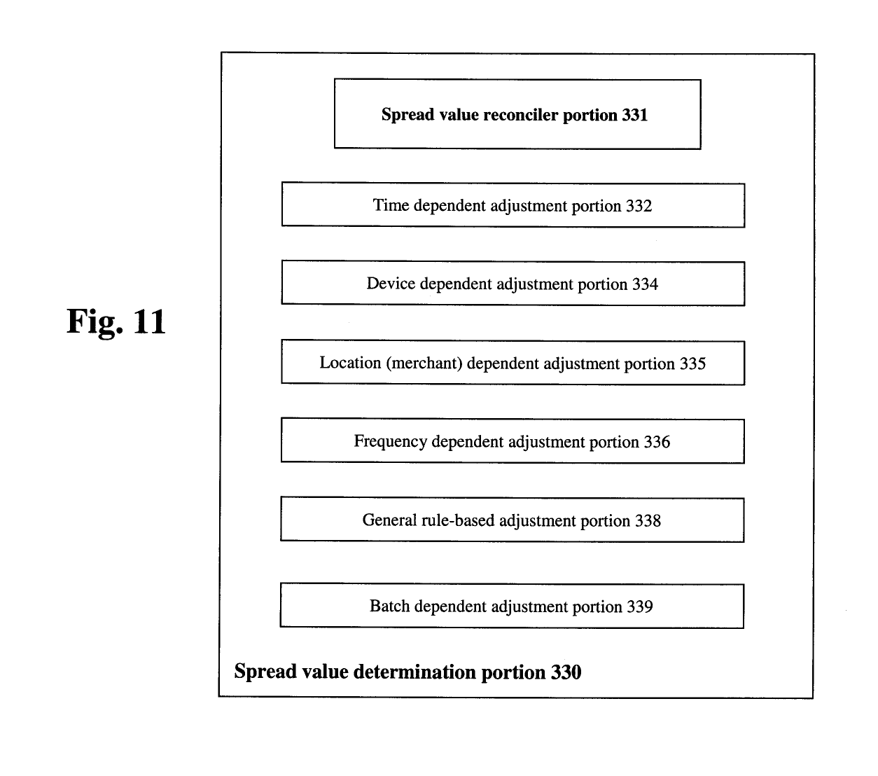

The current transaction count value will of course increment upon every further transaction for that particular account and/or customer, for example. As shown in FIG. 10, as the current transaction count value is so incremented, the transaction count value window 340 may also advance. However, such advancement is assuming that the spread values remain the same. That is, it may be the situation that (as the current transaction count value advances), that the upper spread value 342 becomes less and the lower spread value 344 becomes greater. Such might result in transaction count value window 340 being disposed in a lower range (even with a higher current transaction count value). Further details of the generation of the spread values are described with respect to FIG. 11 below.

In the example of FIG. 10, using specific exemplary numbers, the current transaction count value is 100. The upper spread value 342 (j) is 10, while the lower spread value 344 (n) is 5. This results in a window upper value of 110 and a window lower value of 95. Thus, the transaction count value window 340 is comprised of the values 95 to 110. For example, if a transaction count value of 108 is input, such value of 108 will indeed be authenticated because the value falls within the transaction count value window 340. On the other hand, for example, if a transaction count value of 93 is input, such value of 93 will not be authenticated because the value does not fall within the transaction count value window 340.

FIG. 11 is a block diagram showing further details of the spread value determination portion 330, in accordance with one embodiment of the invention. In particular, FIG. 11 shows various processing components (332-339) that may respectively affect the upper spread value 342, the lower spread value 344 or both. Thus, one processing component (332-339) may effect one spread value and not the other spread value. Thus, for example, the time dependent adjustment portion 332 may effect the upper spread value 342, but not the lower spread value 344. The spread value determination portion 330 may include (or use) all the processing components (332-339) of FIG. 11. Alternatively, only select processing components (332-339) may be included or used. That is, as desired, the authentication portion 216 may utilize suitable logic to determine which processing components (332-339) to use in conjunction with a particular transaction. Such is within the purview of the one of skill in the art, given the disclosure set forth herein. Each processing components (332-339) is described in turn below. Thereafter, aspects of the interrelationship between the processing components (332-339) is described.

In accordance with one embodiment of the invention, the spread value determination portion 330 includes the time dependent adjustment portion 332 (noted above), a device dependent adjustment portion 334, a location dependent adjustment portion 335, a frequency dependent adjustment portion 336, a general rule based adjustment portion 338, and a batch dependent adjustment portion 339. The processing components (332-339) of the spread value determination portion 330 perform processing based on the particulars of the transaction data and/or other information that is available, so as to determine the spread values. The spread value determination portion 330 also includes a spread value reconciler portion 331. Features of the spread value reconciler portion 331 are described below.

The time dependent adjustment portion 332 monitors time attributes of a requested transaction. Such time attributes may be the time that the particular transaction was effected, the time that the transaction was received for processing by the authentication portion 216 and/or some other time attribute. As used herein “time” means the particular hour of the day, as well as the particular date of the year. Thus, the time dependent adjustment portion 332 may use the time of day that the transaction was processed. Further, the time dependent adjustment portion 332 may use some other time attribute. For example, the time dependent adjustment portion 332 might use the time differential between the time that the transaction was effected vis-à-vis the time that the transaction was received for processing, i.e., and adjust the spread value based on such time differential. The time dependent adjustment portion 332 may also take into account known time factors such as daylight savings time, time zone differentials, and/or other known time related issues. For example, the spread value determination portion 330 might know where the transaction was effected, adjust time of processing based on such location and process based on such further determined time. Indeed, in some situations, based on predetermined parameters, the time dependent adjustment portion 332 may simply turn-off as a result of time dependent processing being non-workable (due to some time related situation).

As shown in FIG. 11, the spread value determination portion 330 also includes the device dependent adjustment portion 334. The device dependent adjustment portion 334 adjusts the spread values (meaning it adjusts the upper spread value 342, the lower spread value 344, or both) based on the particular device that was used. In accordance with one embodiment of the invention, the device dependent adjustment portion 334 may use the device differentiator number (DDN) described above in determining which device was used. Alternatively, the device dependent adjustment portion 334 may utilize any attribute of the transaction that would reveal what device was used to effect the transaction. Indeed, it might be the situation that only one device has been issued for a particular account number or user, for example.

Based on the device dependent adjustment portion 334 determining what device was used (in the particular transaction), the device dependent adjustment portion 334 assigns appropriate spread values. For example, a device that is predominately used for batch processing may receive greater spread values than a device that generally performs real time processing/authentication.

The location dependent adjustment portion 335 determines the spread values based on the particular location that the transaction was effected from, such as a particular merchant location. The location might be determined by a merchant identification number, or by some other suitable information. Further, the term “location” as used herein may mean a particular physical location that is determinable, a particular merchant chain, a particular type of merchant, a particular part of some geographical territory and/or any other parameter associated with location. Accordingly, based on the location attributes, the location dependent adjustment portion 335 outputs spread values. In accordance with one embodiment of the invention, the location dependent adjustment portion 335 might in fact use a combination of location particulars in making its determination of spread values. That is, the location dependent adjustment portion 335 might consider the particular type of merchant, as well as the geographical location at which the merchant is located.

The spread value determination portion 330 also includes the frequency dependent adjustment portion 336. The frequency dependent adjustment portion 336 adjusts the spread values based on the frequency of the transactions, e.g., such as the frequency of the transactions that the authentication portion 216 is requested to process. That is, the frequency dependent adjustment portion 336 monitors the number of transactions and adjusts the spread values based thereon. In one embodiment, as the frequency of transactions increases, the spread values also increase, i.e., in that with a greater number of transactions in play, more variance may be expected in the order in which the transactions come into the authentication portion 216. A suitable rule set may be utilized to determine the particular spread values based on variance in frequency of transactions.

The spread value determination portion 330 further includes a general rule based adjustment portion 338. The general rule based adjustment portion 338 is illustrative that any suitable rule may be used to adjust the spread values. Thus, rules not related to time, device, location, frequency and/or batch processing might be used by the spread value determination portion 330.

Lastly, the spread value determination portion 330 includes the batch dependent adjustment portion 339. The batch dependent adjustment portion 339 adjusts the spread values based on a determination of whether the transaction requested and/or other transactions are batched processed, e.g. held by a merchant and submitted to an authenticating entity along with various other transactions. Thus, for example, if the batch dependent adjustment portion 339 determines that a particular transaction is a batched transaction, the batch dependent adjustment portion 339 might output larger spread values than if the transaction was processed by the authenticating entity in real time. Also, the batch dependent adjustment portion 339 might vary output spread values (for a particular requested transactions) based on whether other related transactions have been batched processed. To explain, it may be the case that for a particular requested transaction, it cannot be determined whether the transaction was or was not batched. However, the batch dependent adjustment portion 339 may be able to determine that all other related transactions (e.g. transactions for that same account) have been batched. Thus, the batch dependent adjustment portion 339 may assign larger spread values (assuming that such particular transaction has also been batched).

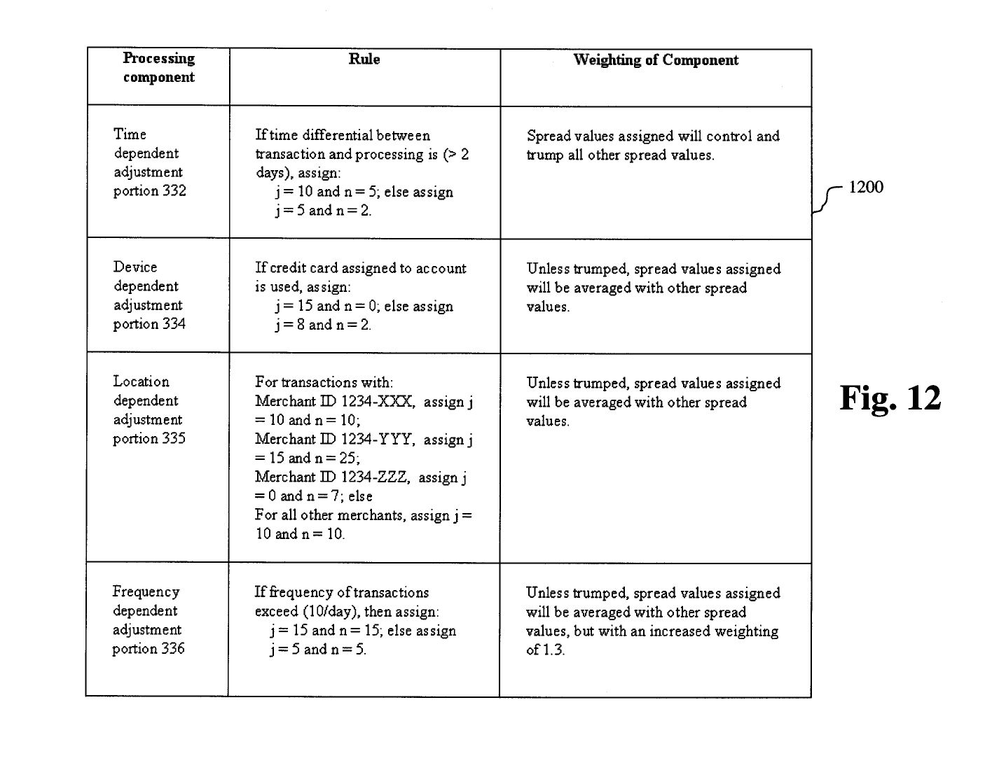

FIG. 12 is a table 1200 showing various processing components (332, 334 and 335) and rules associated therewith, in accordance with one embodiment of the invention. Thus, for example, the time dependent adjustment portion 332 is associated with a particular rule. Such rule is based on the time differential between the time of requesting the transaction and the time of processing the transaction. FIG. 12 also shows that the device dependent adjustment portion 334 and the location dependent adjustment portion 335 are associated with respective rules.

While FIG. 12 shows specific rules, it is appreciated that any of a wide variety of rules (or parameters upon which the rules are based) may be utilized. Thus, FIG. 12 (and the discussions above) is merely illustrative of some possible rules and parameters that might be utilized.

As noted above, the spread value determination portion 330 also includes a spread value reconciler portion 331. Relatedly, the table 1200 includes a “weighting of component” column. As described above, the various processing components (332-339) use rules and apply such rules to particulars of a transaction or other parameters. As a result of applying the rules, the processing components (332-339) in the spread value determination portion 330 output a respective upper spread value 342, lower spread value 344, or both. However, the spread values output by one particular processing component (332-339) may indeed by different than the spread values output by another processing component (332-339).

Thus, processing is provided by the spread value reconciler portion 331 to reconcile the possibly disparate spread values that are generated by the respective processing components (332-339). For example, in accordance with one embodiment of the invention, the spread value reconciler portion 331 simply takes the average of all provided upper spread values to generate the upper spread value 342 that is used by the window generation portion 320. In a similar manner, the spread value reconciler portion 331 simply takes the average of all provided lower spread values to generate the lower spread value 344 that is used by the window generation portion 320. However, various other processing might be used.

For example, as reflected by FIG. 12, a rule may be in place that that spread values assigned by a particular processing component may trump all others. Thus, if such trumping component is called on to provide spread values, then whatever spread values that such trumping component provides will control. Alternately, a trumping component may set a floor or ceiling. To explain, for example, if the time dependent adjustment portion 332 is such a trumping component (and sets the lower spread value 344 as 5 and the upper spread value 342 as 10), such a rule may set such values as a minimum. Thus, while the other spread values may be averaged, for example, the resulting spread values (343, 344) will not be allowed to violate the minimum spread values set by the trumping time dependent adjustment portion 332.

Various mathematical processing may be used by the spread value reconciler portion 331 including averages, weighted averages, trumping values or a combination thereof. For example, a weighted average might be used such that the spread values for a particular processing component counts a varied amount vis-à-vis the other processing components, i.e., based on the particular weighting. Further, the spread value reconciler portion 331 may take the greatest spread values or the least spread values. For example, the spread value reconciler portion 331 may use the greatest upper spread value 342 and the least lower spread value 344. Alternative, the spread value reconciler portion 331 may use the least upper spread value 342 and the greatest lower spread value 344. Alternative, the spread value reconciler portion 331 may use the greatest upper spread value 342 and the greatest lower spread value 344. Other variations may of course be utilized.

As described above, the transaction processing system may be provided with a processing capability to accommodate incrementation of the transaction counter that is not expected by the acquiring entity processing system. In conjunction with such processing, the authentication portion 216 may also perform processing to communicate with the user so as to acquire a further transaction count value, i.e., in the situation where an obtained count value is not valid. That is, in such processing, the authentication portion 216 obtains a first count value and determines that such first count value is not valid. The authentication portion 216 then communicates back to the customer so as to obtain a further count value. The authentication portion 216 may do this multiple times—so as to obtain multiple count values from the customer. Indeed, upon obtaining multiple count values, the authentication portion 216 will be able to determine where a customer device is in the progression of the count values (i.e., if such progression of count values cannot be determined from a single count value). That is, it may be the case that the count values are generated based on some algorithm and that the count values are not generated in order, i.e., 55, 56, 57, 58 . . . In such case, the authentication portion 216 may need to obtain multiple count values so as to know where the customer is in the progression of the count values. Once it is known where the customer is in the progression of the count values, the authentication portion 216 can then utilize the various spread value processing (of the window generation portion 320 for example).

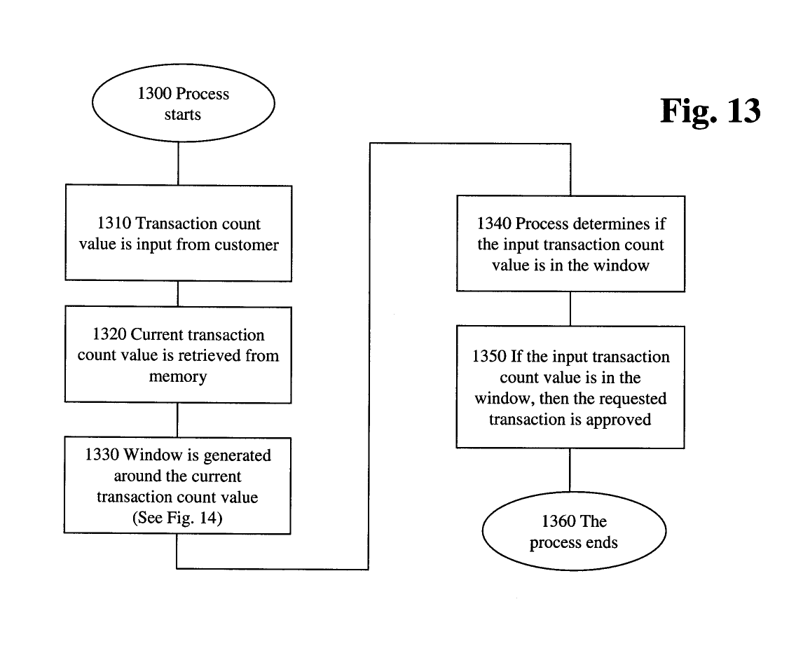

FIGS. 12 and 13 are flowcharts showing further aspects of the method of the invention. The method of FIGS. 12 and 13 may utilize any of the features described herein. The method of FIG. 13 starts in step 1300. Then in step 1310, a transaction count value is input from customer, i.e., from a customer effecting a transaction and requesting authorization.

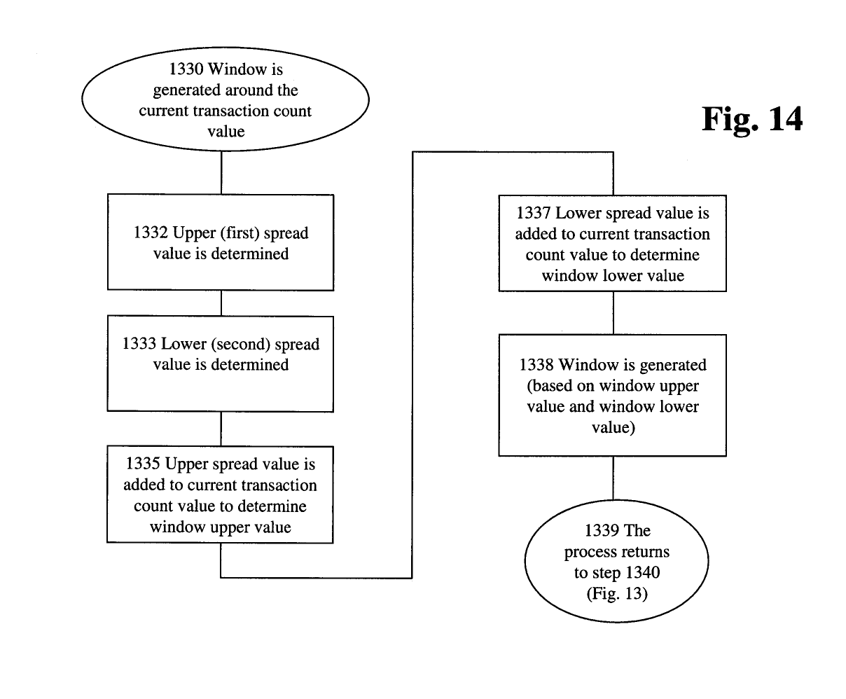

Then, in step 1320, the current transaction count value is retrieved from memory. The current transaction count value is the value that the bank (or other financial entity) has in memory (as what should be the count value). Then in step 1330, a window is generated around the current transaction count value, as shown in further detail in FIG. 14.

After step 1330 of FIG. 13, the process passes to step 1340. In step 1340, the process determines if the input transaction count value is in the window. In step 1350, if the input transaction count value is in the window, then the requested transaction is approved. Otherwise, the transaction is denied. In step 1360, the process ends.

FIG. 14 is a flowchart showing further details of step 1330 of FIG. 13, and generation of the window around the current transaction count value. In FIG. 14, the process starts in step 1330 and passes to step 1332. In step 1332, the upper (first) spread value is determined. Then in step 1333, the lower (second) spread value is determined.

Thereafter, in step 1335, the upper spread value is added to current transaction count value to determine the window upper value, and in step 1337, the lower spread value is added to current transaction count value to determine the window lower value.

Then, in step 1338, the window is generated (based on window upper value and window lower value). Then, in step 1339 of FIG. 14, the process returns to step 1340 of FIG. 13.

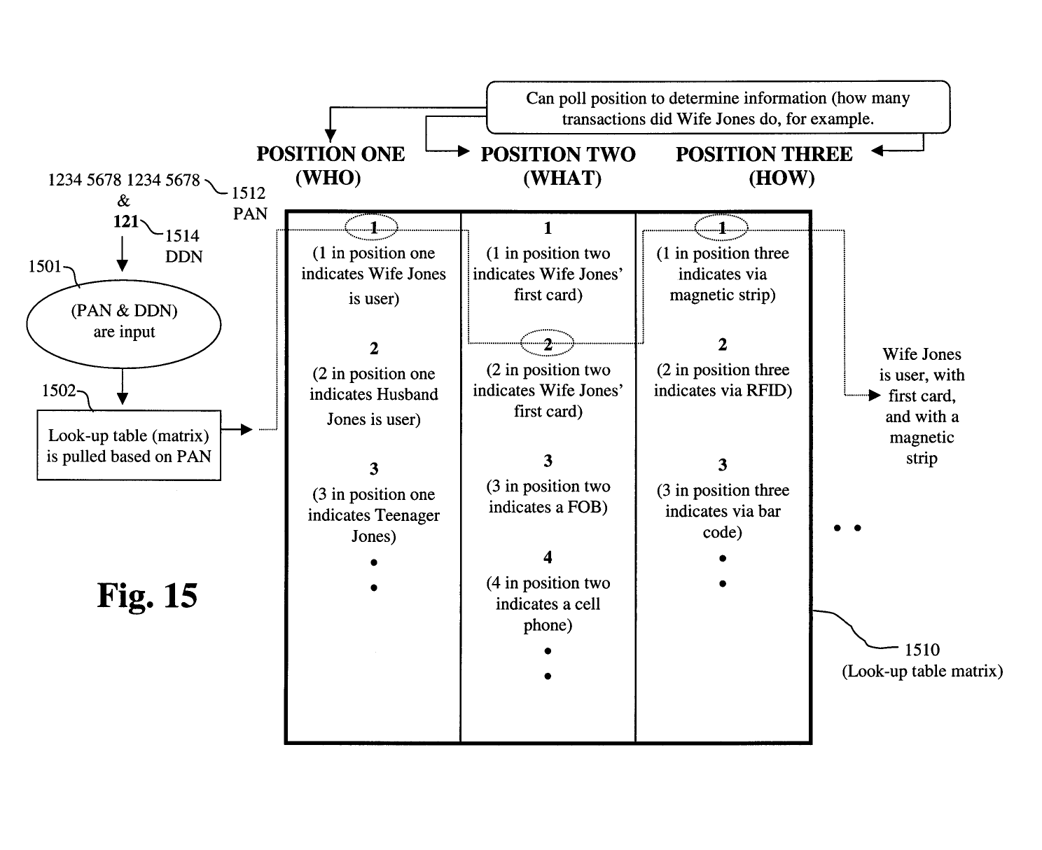

Further aspects of the invention will hereinafter be described with reference to FIG. 15. As set forth above, several payment devices may be associated with a single PAN. Also described above is the generation of the window around a transaction count value. In order to accurately track the transaction count value, as well as for other reasons, it may well be needed to know which device, out of a number of possible devices, submitted the request. That is, each device will advance in transaction count value individually vis-à-vis other devices such that is may be needed to know which device is being used.

FIG. 15 is a diagram showing a look-up table matrix 1510, in accordance with one embodiment of the invention. As shown in FIG. 15, the look-up table matrix 1510 has three positions (from left to right as shown in FIG. 15). Each of the positions provides information based on the particular value at that position. For example, in accordance with the embodiment of FIG. 15, position one contains information regarding “who” made the transaction. Position two contains information regarding “what” made the transaction. Further, position “three” contains information regarding “how” the transaction was made.

As shown in position 1, the particular number (1, 2, or 3) reflects what person is using the device, i.e., what person is associated with the device. Thus, the particular number (1, 2, or 3) indicates Wife Jones, Husband Jones, and Teenager Jones, respectively.

As shown in position 2, the particular number (1, 2, 3 or 4) reflects what device is being used. Thus, in position two, the particular number (1, 2, 3 or 4) indicates Wife Jones' first card, Wife Jones' second card, a FOB, and a cell phone, respectively.

Lastly, as shown in position 3, the particular number (1, 2, or 3) reflects how the transaction is being effected. Thus, the particular number (1, 2, or 3) indicates magnetic strip, RFID (e.g., via Chase Blink Card), and bar code, respectively.

FIG. 15 is illustrative. Information regarding other parameters might be included in addition to or in lieu of the who, what, how parameters shown in FIG. 15. Further, more than three positions might be used (although the three positions arrangement is conducive to transmitting the DDN over a CVV channel, i.e., in lieu of CVV code). More positions would allow more parameters to be included in the DDN. For example, a fourth position might be used as a wildcard of sorts, i.e., a position provided to hold any of a variety of parameters, as desired.

The method reflected in FIG. 15 starts in step 1501 wherein a PAN and DDN are input as a result of a requested transaction. Then, in step 1502, based on the input PAN, the authentication entity system retrieves a look-up table 1510 (that is associated with the particular PAN). The authentication entity system then takes each digit of the DDN and looks up such digit in the look-up table 1510. That is, the authentication entity system takes the first digit of the DDN and looks to the first position in the look-up table 1510 to see what such first digit means, and so forth for the other two digits.

In the example of FIG. 15, the DDN is 121. Thus, the “1” in position one indicates Wife Jones, the “2” in position two indicates Wife Jones' first card; and the 1 in position three indicates a magnetic strip.

In accordance with one embodiment of the invention, the authentication entity system can (and likely would) save the DDNs that were submitted for a particular PAN. Based on such saved DDNs various information may be ascertained regarding the use of the account. For example, a particular position might be polled to determine information, such as how many transactions did Wife Jones do. Any of a variety of analysis might be performed vis-à-vis one card or a plurality of cards collectively, for example.

Further, the authentication entity system can ascertain whether a “bad” combination has been submitted with a request. That is, a bad combination might be DDN=322. Such is a bad combination in that the authentication entity system knows that Wife Jones' credit card does note have a RFID device. Thus, the DDN may well be fraudulent.

Various features of various embodiments are described herein. Such described features may be variously combined such that any one particular feature may be used with any other particular feature. Thus, for example, the features relating to use of a DDN may well be used with features relating to use of the spread values.

Various embodiments of the system of the invention are described above. In addition to the various computer implementation aspects described above, hereinafter, further aspects of contemplated implementation will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the invention.

It is appreciated that in order to practice the method of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it is appreciated that each of the processors and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, two memory portions, as described above, may perform the memory storage performed by one distinct memory portion.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, a LAN, or any client server system that provides communication, for example. Such communications technologies may use any suitable protocol such as TCP/IP, or UDP, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

1. A system that keeps check of financial transactions by maintaining a count of the financial transactions using a register portion, in conjunction with performing authentication further to inputting transaction data from a data-bearing record that is stored in a device, the system comprising:
a communication portion that inputs transaction data received from the data bearing record disposed in the device, the transaction data including an input transaction counter value, the transaction data associated with a transaction;
a processing portion that processes the transaction data, the processing portion including:
a memory portion that stores stored data;
a register portion that maintains a count of financial transactions so as to provide a current transaction count value associated with the device;
an authentication portion that performs authentication processing using a comparison process that utilizes a transaction count value window and the input transaction count value, the transaction count value window being based on the current transaction count value; and
the authentication portion generating an authentication result based on the comparison process; and
the authentication portion outputting the authentication result.

2. The system of claim 1, the authentication portion including a window generation portion, the window generation portion generating the transaction count value window based on the current transaction count value and a first value by defining a range of values extending between the current transaction count value and a first value, and the range of values constituting the transaction count value window.

3. The system of claim 1, the window generation portion generating the transaction count value window based on the current transaction count value, the first value, as well as a second value, by defining a range of values extending between the first value and the second value, the range of values constituting the transaction count value window.

4. The system of claim 3, wherein:
the window generation portion determines the first value by incrementing the current transaction count value by a first spread value; and
the window generation portion determines the second value by decrementing the current transaction count value by a second spread value.

5. The system of claim 4, wherein:
the window generation portion determines the first value by incrementing the current transaction count value by a first spread value is performed according to the relationship:
first value=current transaction count value+first spread value, where the first value, the current transaction count value and the first spread value are integers; and
the window generation portion determines the second value by decrementing the current transaction count value by a second spread value is performed according to the relationship:
second value=current transaction count value−second spread value, where the second value, the current transaction count value and the second spread value are integers.

6. The system of claim 4, wherein the window generation portion includes a spread value determination portion, the spread value determination portion determining at least one of the first spread value and the second spread value.

7. The system of claim 6, the spread value determination portion determining at least one of the first spread value and the second spread value by retrieving at least one of the first spread value and the second spread value from a memory portion.

8. The system of claim 6, the spread value determination portion determining at least one of the first spread value and the second spread value based on a time value associated with the transaction, the time value contained in the transaction data.

9. The system of claim 8, the time value being a time of day that the transaction was effected.

10. The system of claim 8, the time value being a duration of time between when the transaction was effected and when the transaction is processed by the spread value determination portion.

11. The system of claim 6, the spread value determination portion determining at least one of the first spread value and the second spread value based on the device that generated the transaction data.

12. The system of claim 6, the spread value determination portion determining at least one of the first spread value and the second spread value based on a location that the transaction was effected.

13. The system of claim 12, wherein the location is a geographical location.

14. The system of claim 12, wherein the location is a type of merchant.

15. The system of claim 6, the spread value determination portion determining at least one of the first spread value and the second spread value based on the frequency of plurality of transactions associated with the device.

16. The system of claim 15, the spread value determination portion increasing at least one of the first spread value and the second spread value as the frequency of the plurality of transactions increases.

17. The system of claim 6, the spread value determination portion determining at least one of the first spread value and the second spread value based on a rule set.

18. The system of claim 6, the spread value determination portion determining at least one of the first spread value and the second spread value based on a determination of whether the transaction was processed using batch processing.

19. The system of claim 6, the spread value determination portion determining the spread value based on at least one selected from the group consisting of time, location, frequency of transactions and device used.

20. The system of claim 1, the authentication portion including a count value comparison portion, the count value comparison portion performing the authentication processing using the comparison process by determining if the input transaction count value is disposed in the transaction count value window.

21. The system of claim 1, the authentication portion including a window generation portion, the window generation portion generating the transaction count value window based on the current transaction count value, a first value and a second value by defining a range of values extending between the first value and the second value, and the range of values constituting the transaction count value window.

22. The system of claim 1, in which the device is one of a transponder and an RFID device.

23. The system of claim 1, in which an account number and an input device differentiator number, associated with the device, are used by the processing portion to track and document activity associated with the account number and the input device differentiator number, the processing portion also separately tracking and documenting activity of other device differentiator numbers associated with the same account number.

24. The system of claim 1, the processing portion further including a device identification portion that identifies the device based on the device differentiator number and an account number, the account number being derived from the transaction data.

25. The system of claim 1, the device associated with an account number.

26. A method to keeps check of financial transactions by maintaining a count of the financial transactions using a register portion, in conjunction with performing authentication further to inputting transaction data from a data-bearing record that is stored in a device, the method comprising:
inputting transaction data received from the data bearing record, the transaction data including an input transaction count value;
performing authentication processing using a comparison process that utilizes a transaction count value window and the input transaction count value, the transaction count value window being based on the current transaction count value; and
performing authentication processing based on the comparison process; and
generating and outputting an authentication result, based on the authentication processing.

27. The method of claim 1, including:
providing a register portion that maintains a count of financial transactions so as to provide a current transaction count value associated with the device; and
determining which device is being used using a device differentiator number, that is included with the transaction data, in conjunction with a look-up table matrix.

28. The method of claim 27, wherein the device differentiator number includes multiple digits, each such digit reflective of a particular parameter associated with the device.

29. The method of claim 28, wherein the device differentiator number includes three digits, indicative of who, what and how parameters of the transaction.

30. The method of claim 29, further including analyzing the device differentiator number to ascertain if the device differentiator number reflects a bad combination.

31. A system that keeps check of financial transactions by maintaining a count of the financial transactions using a register portion, in conjunction with performing authentication further to inputting transaction data from a data-bearing record that is stored in a device, the system comprising:
a communication portion that inputs transaction data received from the data bearing record disposed in the device, the transaction data including an input transaction counter value, the transaction data associated with a transaction;
a processing portion that processes the transaction data, the processing portion including:
a memory portion that stores stored data;
a register portion that maintains a count of financial transactions so as to provide a current transaction count value associated with the device;
an authentication portion that performs authentication processing using a comparison process that utilizes a transaction count value window and the input transaction count value, the transaction count value window being based on the current transaction count value; and
the authentication portion generating an authentication result based on the comparison process; and
the authentication portion outputting the authentication result; and
the window generation portion generating the transaction count value window based on the current transaction count value, the first value, as well as a second value, by defining a range of values extending between the first value and the second value, the range of values constituting the transaction count value window; and
wherein:
the window generation portion determines the first value by incrementing the current transaction count value by a first spread value; and
the window generation portion determines the second value by decrementing the current transaction count value by a second spread value, and wherein:
the window generation portion determines the first value by incrementing the current transaction count value by a first spread value is performed according to the relationship:
first value=current transaction count value+first spread value, where the first value, the current transaction count value and the first spread value are integers; and
the window generation portion determines the second value by decrementing the current transaction count value by a second spread value is performed according to the relationship:
second value=current transaction count value−second spread value, where the second value, the current transaction count value and the second spread value are integers; and
wherein the window generation portion includes a spread value determination portion, the spread value determination portion determining at least one of the first spread value and the second spread value, such determining being based on at least one selected from the group consisting of time of transaction, frequency of transactions, and location of transaction; and
wherein the device is an RFID device.
